(19) United States
(12) Patent Application Publication
(10) Pub. No.: US 2024/0424526 A1
(43) Pub. Date: Dec. 26, 2024

(54) CURING OF COATING COMPOSITIONS BY APPLICATION OF PULSED INFRARED RADIATION

(71) Applicant: PPG Industries Ohio, Inc., Cleveland, OH (US)

(72) Inventors: Hannelore Künstler, Stuttgart (DE); Sven Reil, Grossbottwar (DE); Axel Nagel, Oberstenfeld (DE)

(73) Assignee: PPG Industries Ohio, Inc., Cleveland, OH (US)

(21) Appl. No.: 18/691,502

(22) PCT Filed: Sep. 12, 2022
(86) PCT No.: PCT/US2022/076276

§ 371 Date: Mar. 13, 2024

Related U.S. Application Data
(60) Provisional application No. 63/261,270, filed on Sep. 16, 2021.

(51) Int. Cl. B05D 3/02

(52) U.S. Cl. CPC B05D 3/0263; B05D 2401/10; B05D 2502/00; B05D 2518/00; B05D 2518/12; B05D 2602/00

(57) ABSTRACT

The present disclosure relates to a method for coating a substrate by applying a coating composition on a surface of a substrate and applying a pulsed infrared radiation to form a cured coating. The present disclosure further relates to coated substrates obtained by such method. Moreover, the present disclosure concerns the use of a coating composition and use of pulsed infrared radiation.

### TECHNICAL FIELD

The present disclosure relates to a method for coating a substrate by applying a coating composition on a surface of a substrate and applying a pulsed infrared radiation to form a cured coating. The present disclosure further relates to coated substrates obtained by such method. Moreover, the present disclosure concerns the use of a coating composition and use of pulsed infrared radiation.

### TECHNICAL BACKGROUND

It is often desirable to provide the surface of substrates of various technical fields, such as vehicles, furniture, packaging substrates, etc., with a cured coating composition providing resistance against abrasion, corrosion, further physical and chemical impact, and the like. Most curing methods require a considerable amount of time and energy.

Thus, it is an object of the present disclosure to provide a more efficient process for curing a coating applied to a part of the surface of a substrate in order to provide it with, e.g., abrasion resistance, corrosion resistance, chemical resistance, and the like, while reducing energy consumption and processing time. Moreover, it is desirable to provide enhanced cured film properties, such as resistance to chemicals, corrosion and abrasion.

This object is solved by the subject-matter defined in the appended claims. By applying pulsed infrared radiation having a peak wavelength in the range of from 3 μm to 10 μm at a pulse duration of less than 100 μs to a coating composition curing time can be reduced significantly. In addition, it has surprisingly been found that properties of the cured coatings, such as, for instance microhardness, may be improved in comparison to, e.g., oven baking. Additionally, scratch and mar resistance and/or chemical resistance of the cured substrates of the present disclosure may be significantly improved.

### SUMMARY

The present disclosure relates to a method for coating a substrate comprising: (i) applying a coating composition to a part of a surface of the substrate, wherein the coating composition comprises a film-forming resin and a crosslinking agent suitable for crosslinking the film-forming resin; and (ii) applying pulsed infrared radiation having a peak wavelength in the range of from 3 μm to 10 μm at a pulse duration of less than 100 μs to the applied coating composition to form a cured coating.

The present disclosure further relates to a coated substrate obtained by the method according to the present disclosure.

The present invention also is directed to a use of coating composition comprising a film-forming resin and a crosslinking agent suitable for crosslinking the film forming resin in a method of curing a coating composition by applying pulsed infrared radiation having a peak wavelength in the range of from 1 μm to 10 μm at a pulse duration of less than 100 μs to the coating.

The present invention further relates to a use of pulsed infrared radiation having a peak wavelength in the range of from 1 μm to 10 μm to enhance the physical and/or chemical properties of a cured coating formed from a 1K coating composition comprising a film-forming resin and a crosslinking agent suitable for crosslinking the film forming resin to a part of a surface of the substrate.

### DETAILED DESCRIPTION

For purposes of the following detailed description, it is to be understood that the disclosure may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “a” polymer, “a” crosslinking agent, and the like refer to one or more of any of these items.

The present disclosure relates to a method for coating a substrate. The method according to the disclosure comprises (i) applying a coating composition to a part of a surface of the substrate; and (ii) applying pulsed infrared radiation having a peak wavelength in the range of from 3 μm to 10 μm at a pulse duration of less than 100 μs to the applied coating composition to form a cured coating. The coating composition of the present disclosure comprises a film-forming resin and a crosslinking agent suitable for crosslinking the film-forming resin.

As used herein, the term “film-forming resin” refers to resins that can form a self-supporting continuous film on a horizontal surface of a substrate upon removal of any diluents or carriers present in the composition or upon curing at ambient conditions, e.g., at a temperature in the range of 20 to 25° C., or at elevated temperatures, e.g., at a temperature in the range of 40 to 200° C. The terms “resin” and “resinous” and the like are used interchangeably with the terms “polymer” and “polymeric” and the like. Further, the term “polymer” is used herein in its common meaning in the art, referring to macromolecular compounds, i.e., compounds having a relatively high molecular weight (e.g., 500 Da or more), the structure of which comprises multiple repetition units (also referred to as “mers”) derived, actually or conceptually, from chemical species of relatively lower molecular mass. Unless indicated otherwise, molecular weights are on a weight average basis (“M_{w}”) and are determined by gel permeation chromatography using polystyrene standards.

By ambient conditions is meant that the composition is cured without the aid of heat, for example, without baking in an oven, use of forced air, or the like.

Examples of film-forming resins comprise acrylic resins, vinylic resins, polyester resins, polysiloxane resins, epoxy resins, polyurethane resins, polyamide resins, copolymers thereof, and mixtures thereof.

The acrylic resins may be homopolymers or copolymers, which can be obtained by polymerizing one or more monomers comprising substituted or unsubstituted (meth) acrylic acids and (meth) acrylates. Herein, the terms “(meth) acrylic acid” and “(meth) acrylate” and similar terms refer both to the acrylic acid or acrylate and the corresponding methacrylic acid or methacrylate, respectively. Suitable (meth) acrylates can include, but are not limited to, alkyl (meth) acrylates, cycloalkyl (meth) acrylates, alkylcycloalkyl (meth) acrylates, aralkyl (meth) acrylates, alkylaryl (meth) acrylates, aryl (meth) acrylates and functional groups-containing (meth) acrylates. As used herein, the term “functional group” refers to a group that includes one or a plurality of atoms other than hydrogen and sp³ carbon atoms. Examples of functional groups include, but are not limited to, hydroxyl, carboxylic acid, amido, isocyanate, urethane, thiol, amino, sulfone, sulfoxide, phosphine, phosphite, phosphate, halide, and the like. Non-limiting examples of acrylic resins may include acrylic resins derived from methyl (meth) acrylate, ethyl (meth) acrylate, propyl (meth) acrylate, butyl (meth) acrylate, iso-butyl (meth) acrylate, 2-ethyl hexyl (meth) acrylate, iso-octyl (meth) acrylate, isobornyl (meth) acrylate, isodecyl (meth) acrylate, lauryl (meth) acrylate, tridecyl (meth) acrylate, tetradecyl (meth) acrylate, hexadecyl (meth) acrylate, octadecyl (meth) acrylate, stearyl (meth) acrylate, benzyl (meth) acrylate, 2-phenoxyethyl (meth) acrylate, 3,3,5-trimethyl-cyclohexyl (meth) acrylate, 3-methylphenyl (meth) acrylate, 1-naphtyl (meth) acrylate, 3-phenyl-n-propyl (meth) acrylate, 2-phenyl-aminoethyl (meth) acrylate, hydroxyethyl (meth) acrylate, hydroxypropyl (meth) acrylate, 4-hydroxybutyl (meth) acrylate, glycidyl (meth) acrylate or combinations thereof. According to the present disclosure, the acrylic resins may have a hydroxyl value in a range of 20 to 400, such as of 30 to 350, or of 40 to 300, or of 50 to 250. The hydroxyl value may be determined according to DIN EN ISO 4629-1:2016. Suitable acrylic resins include, but are not limited to acrylic resins under the trademark SETALUX®, such as SETALUX® 1776 VS-65, SETALUX® 1774 SS-70, SETALUX® 1797 SS-70, SETALUX® 1762 W-70, SETALUX® 1760 VB-64, SETALUX® 1795 VX-74, SETALUX® D A 870 BA, commercially available from Allnex Germany GmbH (Germany) and acrylic resins under the trademark VIACRYL®, such as VIACRYL SC 370/75SNA, commercially available from Allnex Germany GmbH (Germany).

Vinylic resins may be homopolymers or copolymers, which can be obtained by polymerizing one or more monomers comprising vinyl aromatic compounds, such as styrene and vinyl toluene; nitriles, such as (meth) acrylonitrile; vinyl and vinylidene halides, such as vinyl chloride and vinylidene fluoride; and vinyl esters, such as vinyl acetate. Suitable vinylic resins can be exemplified by vinylic resins under the trademark LUMIFLON™ available from AGC Chemicals Europe, Ltd. (Netherlands).

Polyester resins may be prepared in a known manner, e.g., by condensation of a polyol and a polyacid or by ring-opening polymerization of lactones. As used herein, the term “polyol” refers to a compound having more than one hydroxyl group per molecule, e.g., 2, 3, 4, 5, 6 or more hydroxyl groups per molecule, and the term “polyacid” refers to a compound having more than one carboxylic acid group per molecule, e.g., 2, 3, 4, 5, 6 or more carboxylic acid groups per molecule, and includes anhydrides of the corresponding acid. Suitable polyols include, but are not limited to, alkylene glycols, such as ethylene glycol, propylene glycol, butylene glycol, 1,6-hexylene glycol, diethylene glycol, dipropylene glycol, triethylene glycol, tripropylene glycol, polyethylene glycol having a molecular weight in the range of 200 to 10.000 g/mol, polypropylene glycol having a molecular weight in the range of 200 to 10.000 g/mol, polybutylene glycol having a molecular weight in the range of 300 to 10.000 g/mol and neopentyl glycol; bisphenol A; hydrogenated bisphenol A; bisphenol F; hydrogenated bisphenol F; cyclohexandiol; propanediols such as 1,2-propanediol, 1,3-propanediol, butyl ethyl propanediol, 2-methyl-1,3-propanediol and 2-ethyl-2-butyl-1,3-propanediol; butanediols such as 1,4-butanediol, 1,3-butanediol, 2,3-butanediols, 1,2-butanediols, 3-methyl-1,2-butanediol and 2-ethyl-1,4-butanediol; pentanediols such as 1,2-pentanediol, 1,5-pentanediol, 1,4-pentanediol, 3-methyl-4,5-pentanediol and 2,2,4-trimethyl-1,3-pentanediol; hexandiols such as 1,6-hexanediol, 1,5-hexanediol, 1,4-hexanediol and 2,5-hexanediol; poly (caprolactone) diols having a molecular weight in the range of 400 to 10.000 g/mol; polyether glycols, such as poly (oxytetramethylene) glycol; trimethylolpropane; pentaerythritol; dipentaerythritol; trimethylolethane; trimethylolbutane; dimethylolcyclohexane and glycerol. Suitable polyacids may include, but are to limited to, maleic acid; fumaric acid; itaconic acid; adipic acid; azelaic acid; succinic acid; sebacic acid; glutaric acid; phthalic acid; isophthalic acid; 5-tert-butylisophthalic acid; tetrachlorophthalic acid; trimellitic acid;

naphthalene dicarboxylic acid; naphthalene tetracarboxylic acid; terephthalic acid, hexahydrophthalic acid; methyl hexahydrophthalic acid; dimethyl terephthalic acid; cyclohexane dicarboxylic acid, 1,3-cyclohexane dicarboxylic acid; 1,4-cyclohexane dicarboxylic acid; tricyclodecanepolycarboxylic acid, endomethylenetetrahydrophthalic acid; endoethylenehexahydrophthalic acid; cyclohexane tertracarboxylic acid; cyclobutanetetracarboxylic acid and anhydrides of all the aforementioned polyacids. Suitable lactones may include, but are not limited to, β-propiolactone; γ-butyrolactone; δ-valerolactone; ε-caprolactone; α-angelica lactone; and mixtures thereof. Suitable polyester resins include, but are not limited to polyester resins under the trademark SETAL®, such as SETAL® 1715 VX-74, SETAL® 91703 SS-53, and SETAL® 91715 SS-55 commercially available from Allnex Germany GmbH (Germany).

Polysiloxane resins may include, but are not limited to, alkyl substituted polysiloxanes, aryl polysiloxanes, copolymers, blends and mixtures thereof. The alkyl substitution may be selected from short chain alkyl groups of 1 to 4 carbon atoms, such as methyl or propyl. The aryl substitution may comprise phenyl groups. Suitable polysiloxane resins include, but are not limited to, Silres® 601 or Silres® M 50 E, both commercially available from Wacker Chemie AG (Germany), and DOWSIL™ RSN-6018, commercially available from Dow Chemical Company (USA).

Epoxy resins may be prepared in a known manner, e.g., by reacting a compound comprising an epoxide functionality and a cyclic co-reactant comprising at least two hydroxyl groups. Examples of suitable compounds comprising one epoxide functionality include, but are not limited to, glycidol; epichlorohydrin; glycidol amines and mixtures thereof. As used herein, the terms “epoxy” and “epoxide” are used interchangeably. Examples of suitable cyclic co-reactants comprising at least two hydroxy groups include, but are not limited to, bisphenol A; hydrated bisphenol A; bisphenol F; hydrated bisphenol F; novolac resins such as phenolic novolac, cresol novolac; and mixtures thereof. Suitable epoxy resins include, but are not limited to, Eponex 1510, Eponex 1513, Epikote Resin 862 and Epikote Resin 828 commercially available from Hexion (USA); Epodil 757 commercially available from Evonik Corporation (Germany); Araldite GY 2600, Araldite GY 281 and Araldite EPN 1138 commercially available from Huntsman (USA).

Polyurethane resins can be prepared in a known manner, e.g., by reacting a polyisocyanate and a polyol. As used herein, the term “polyisocyanate” refers to a compound having more than one isocyanate group per molecule, e.g., 2, 3, 4, 5, 6, or more isocyanate groups per molecule. Suitable polyisocyanates include aliphatic polyisocyanates, such as 2,2,4-trimethyl hexamethylene diisocyanate, 2,4,4-trimethyl hexamethylene diisocyanate, 1,6-hexamethylene diisocyanate; cycloaliphatic polyisocyanates, such as isophorone diisocyanate and 4,4′-methylene-bis (cyclohexyl isocyanate); aromatic polyisocyanates such as 4,4′-diphenylmethane diisocyanate, toluene diisocyanate, 1,2,4-benzene triisocyanate, tetramethyl xylylene diisocyanate and polymethylene polyphenyl isocyanate. Non-limiting examples of suitable polyols may be the polyols described above for producing the polyester resins. Suitable polyurethane resins include, but are not limited to the reaction product of Desmodur N 3300 (commercially available from Covestro (Germany)) with an alkylene glycol, such as ethylene glycol or propylene glycol.

Suitable polyamide resins may be prepared in a known manner, e.g., by polymerizing a polyamine and a polyacid or by ring-opening polymerization of lactams. Herein, the term “polyamine” refers to a compound having more than one amine group per molecule, e.g., 2, 3, 4, 5, 6, or more amine groups per molecule. Suitable polyamines include, but are not limited to, aliphatic diamines such as 1,2-ethanediamine, 1,2-propanediamine, 1,3-propanediamine, 1,2-butanediamine, 1,3-butanediamine, 1,4-butanediamine, 1,3-pentanediamine, 1,5-pentanediamine, 1,6-hexanediamine, 2-methyl-1,5-pentanediamine, 2,5-dimethylhexane-2,5-diamine, 2,2,4-trimethyl-1,6-hexanediamine, 2,4,4-trimethyl-1,6-hexanediamine, 1,7-heptanediamine, 1,8-octanediamine, 1,9-nonanediamine and 1,10-decanediamine; cycloaliphatic diamines such as 2,4′-diamino dicyclohexylmethane, 4,4′-diamino dicyclohexylmethane, 3,3′-dimethyl-4,4′-diamino dicyclohexylmethane and 3,3′-diethyl-4,4′-diaminodicyclohexylmethane; and aromatic diamines such as 1,2-benzenediamine, 1,3-benzenediamine, 1,4-benzenediamine, 1,5-naphthalenediamine, 1,8-naphthalenediamine, 2,4-toluenediamine, 2,5-toluenediamine, 2,6-toluenediamine, and 3,3′-dimethyl-4,4′-biphenyldiamine. Non-limiting examples of suitable polyacids may include those listed above for preparing polyesters. Suitable lactams may include, but are not limited to, β-propiolactam; ≡-butyrolactam; δ-valerolactam; ε-caprolactam; and mixture thereof. Suitable polyamide resins include, but are not limited to polyamide resins under the trademark Flex-Rez™, such as Flex-Rez™ 0080CS, Flex-Rez™ 1060CS, Flex-Rez™ 1074 CS A, commercially available from Lawter (USA).

In particular, the film forming resin may comprise acrylic polyols, acrylic polyesters, or a combination thereof.

The film-forming resin may be present in an amount of at least 25 wt.-%, such as at least 30 wt.-%, such as at least 40 wt.-%, such as at least 50 wt.-%, based on the total weight of solids in the coating composition. The film-forming resin may be present in an amount of no more than 95 wt.-%, such as no more than 90 wt.-%, such as no more than 85 wt.-%, such as no more than 80 wt.-%, based on the total weight of solids in the coating composition. Ranges of film-forming resins may include, for example, from 25 to 95 wt.-%, such as from 25 to 90 wt.-%, such as from 25 to 85 wt.-%, such as from 25 to 80 wt.-%, such as from 30 to 95 wt.-%, such as 30 to 90 wt.-%, such as 30 to 85 wt.-%, such as 30 to 80 wt.-%, such as 40 to 95 wt.-%, such as 40 to 90 wt.-%, such as 40 to 85 wt.-%, such as 40 to 80 wt.-%, such as 50 to 95 wt.-%, such as 50 to 90 wt.-%, such as 50 to 85 wt.-%, such as 50 to 80 wt.-%, based on the total weight of solids in the coating composition. The film-forming resin may be present in the coating composition in the range between any of the above-mentioned values such as from 25 to 95 wt.-%, such as from 30 to 90 wt.-%, such as from 35 to 85 wt.-%, such as from 40 to 80 wt.-%, such as from 50 to 80 wt.-%, based on the total weight of solids in the coating composition.

The coating composition disclosed herein further comprises a crosslinking agent suitable for crosslinking the film-forming resin. As used herein, the term “crosslinking” refers to the formation of covalent bonds between polymer chains of the constituent polymer molecules. The terms “crosslinking agent”, “curing agent” and “crosslinker” are herein used interchangeably. Curing or crosslinking reactions may be induced, for example, by exposing the coating composition to heat or radiation, but may also be carried out at ambient conditions to form a cured coating. The crosslinking agent may comprise a polyepoxide, a polyisocyanate, an amino resin, or a mixture thereof. The crosslinking agent may comprise an amino resin. The crosslinking agent may often comprise a melamine resin.

Suitable polyepoxides may include, but are not limited to, low molecular weight polyepoxides, e.g., polyepoxides having a molecular weight in the range of from 200 to 500 g/mol, as well as higher molecular weight polyepoxides, e.g., polyepoxides having a molecular weight in the range of from 500 to 10.000 g/mol. Suitable low molecular weight polyepoxides include, but are not limited to, 3,4-epoxycyclohexylmethyl, 3,4-epoxycyclohexanecarboxylate and bis (3,4-epoxy-6-methylcyclohexyl-methyl) adipate, bisphenol A diglycidyl ether, bisphenol E diglycidyl ether and bisphenol F diglycidyl ether. Suitable higher molecular weight polyepoxides may include, but are not limited to, polyglycidyl ethers of cyclic polyols, for example, polyglycidyl ethers of polyhydric phenols such as bisphenol A, bisphenol F, resorcinol, hydroquinone, benzenedimethanol, phloroglucinol, and catechol; or polyglycidyl ethers of polyhydric alcohols such as aliphatic polyols, particularly cycloaliphatic polyols such as 1,2-cyclohexane diol, 1,4-cyclohexane diol, 2,2-bis (4-hydroxycyclohexyl) propane, 1,1-bis (4-hydroxycyclohexyl) ethane, 2-methyl-1,1-bis (4-hydroxycyclohexyl) propane, 2,2-bis (4-hydroxy-3-tertiarybutylcyclohexyl) propane, 1,3-bis (hydroxymethyl) cyclohexane and 1,2-bis (hydroxymethyl) cyclohexane. Examples of aliphatic polyols may include, but are not limited to inter alia, trimethylpentanediol and neopentyl glycol. Suitable polyepoxides include, but are not limited to EPONEX™ 1510, Epon® 828, EPIKOTE™ Resin 828, commercially available from Hexion Inc. (USA).

Suitable polyisocyanates can be aliphatic, aromatic, or a mixture thereof. As used herein, the term “polyisocyanate” is intended to include blocked polyisocyanates as well as unblocked polyisocyanates. As used herein, the term “blocked polyisocyanate” refers to adducts derived from the equilibrium reaction of an isocyanate with a blocking agent, whereby the adduct is thermally instable and dissociates (unblocks) at elevated temperatures, such as temperatures above 120° C. The term “unblocked isocyanate” refers to a polyisocyanate without blocking agents. The polyisocyanate may be prepared from a variety of isocyanate-containing materials. Examples of suitable polyisocyanates include trimers prepared from, but not limited to, toluene diisocyanate, 4,4′-methylene-bis (cyclohexyl isocyanate), isophorone diisocyanate, an isomeric mixture of 2,2,4- and 2,4,4-trimethyl hexamethylene diisocyanate, 1,6-hexamethylene diisocyanate, tetramethyl xylylene diisocyanate and 4,4′-diphenylmethylene diisocyanate. Isocyanate groups of the polyisocyanates may be blocked or unblocked as desired. Examples of suitable blocking agents include those materials which would unblock at elevated temperatures, e.g., at temperatures above 120° C., such as lower aliphatic alcohols having 1 to 6 carbon atoms including methanol, ethanol, and n-butanol; cycloaliphatic alcohols such as cyclohexanol; aromatic alkyl alcohols such as phenyl carbinol and methylphenyl carbinol; and phenolic compounds such as phenol itself and substituted phenols wherein the substituents do not affect coating operations, such as cresol and nitrophenol. Glycol ethers may also be used as blocking agents. Suitable glycol ethers include ethylene glycol butyl ether, diethylene glycol butyl ether, ethylene glycol methyl ether and propylene glycol methyl ether. Other suitable blocking agents include oximes such as methyl ethyl ketoxime, acetone oxime and cyclohexanone oxime, lactams such as epsilon-caprolactam, pyrazoles such as dimethyl pyrazole, and amines such as dibutyl amine. Suitable polyisocyanates include, but are not limited to Desmodur ultra grade polyisocyanates, such Desmodur ultra DN, Desmodur ultra N 3300, Desmodur ultra IL EA and Desmodur Ultra N 3300 BA/SN commercially available from Covestro (Germany).

Suitable amino resins can be obtained from the condensation reaction of an aldehyde, such as formaldehyde, with a compound comprising at least two amine or amide groups per molecule. Suitable examples of aldehydes include, but are not limited to, formaldehyde, acetaldehyde, crotonaldehyde and benzaldehyde. Suitable examples of compounds comprising at least two amine or amide groups include, but are not limited to, melamine, urea and benzoguanamine. Suitably, the amino resins may be etherified, typically, with an alcohol, such as methanol, ethanol, butanol or mixtures thereof. Suitable amino resins include, but are not limited to Maprenal® Amino Resin, such as Maprenal MF 612/70B, Maprenal MF 613/71B and Maprenal MF 650/55IB commercially available from Prefere Resin Holding Gmbh (Germany), Cymel® Amino Crosslinkers, such as Cymel 303, Cymel 202, Cymel 1161, Cymel 325 and Cymel 1133 commercially available from Allnex Industries (Germany); Setamine® aminoresins, such as Setamine US-138 BB-70, and Setamine US-146 BB-72 commercially available from Allnex (Germany).

The crosslinking agent may be present in an amount of at least 5 wt.-%, such as at least 10 wt.-%, such as at least 15 wt.-%, such as at least 20 wt.-%, based on the total weight of solids in the coating composition. The crosslinking agent may be present in an amount of no more than 75 wt.-%, such as no more than 70 wt. %, such as no more than 60 wt.-%, such as no more than 50 wt.-%, based on the total weight of solids in the coating composition. Ranges of crosslinking agent may include, for example, from 5 to 75 wt.-%, such as from 5 to 70 wt.-%, such as from 5 to 60 wt.-%, such as from 5 to 50 wt.-%, such as from 10 to 75 wt. %, such as 10 to 70 wt.-%, such as 10 to 60 wt.-%, such as 10 to 50 wt.-%, such as 15 to 75 wt.-%, such as 15 to 70 wt.-%, such as 15 to 60 wt.-%, such as 15 to 50 wt.-%, such as 20 to 75 wt.-%, such as 20 to 70 wt.-%, such as 20 to 60 wt.-%, such as 20 to 50 wt.-%, based on the total weight of solids in the coating composition. The crosslinking agent may be present in the coating composition in range between any of the above-mentioned values such as from 5 to 75 wt.-%, such as from 10 to 70 wt.-%, such as from 15 to 60 wt.-%, such as from 20 to 50 wt.-%, based on the total weight of solids in the coating composition.

The coating composition may further comprise a solvent or a mixture of solvents. Suitable solvents include water, organic solvents and a mixture thereof. The organic solvent may comprise any suitable organic solvents known in the art. Non-limiting examples of suitable organic solvents may include, but are not limited to, alcohols, glycol ethers, esters, ether esters and ketones, aliphatic and/or aromatic hydrocarbons, such as, for example, methanol, ethanol, isopropanol, n-butanol, 2-butanol, tridecyl alcohol, methyl isobutyl ketone, methyl ethyl ketone, 3-butoxy-2-propanol, ethyl 3-ethoxypropionate, butyl glycol, butyl glycol acetate, butanol, dipropylene glycol methyl ether, diethylene glycol monobutyl ether, butyl glycolate, hexane, heptane, octane, toluene, xylene, ethyl acetate, propyl acetate, isopropyl acetate, butyl acetate, isobutyl acetate, 2-butoxyethyl acetate, amyl acetate, isoamyl acetate, diethylene glycol butyl ether acetate, acetone, xylene, toluene and the like. The solvent may be present in the coating composition in an amount of 5-70 wt.-%, such as 10-65 wt.-%, such as 15-60 wt.-%, such as 20-55 wt.-%, such as 30-50 wt.-%, based on the total weight of the coating composition.

The coating composition may be a water-borne coating composition, a solvent-borne coating composition or a powdered coating composition.

The coating composition according to the present disclosure may be a solvent-borne coating composition. As used herein, the term “solvent-borne coating composition” refers to a coating composition comprising a solvent mixture comprising an organic solvent and less than 50 wt.-% of water, such as less than 40 wt.-% of water, such as less than 30 wt.-% of water, such as less than 20 wt. % of water, such as less than 10 wt.-% of water, such as less than 5 wt.-% of water, such as less than 2 wt.-% of water, such as less than 1 wt.-% of water, based on the total weight of the solvent mixture. The solvent-borne coating composition may be free of water, i.e., the solvent-borne coating composition may comprise less than 0.5 wt.-% of water, such as less than 0.2 wt.-% of water, such as less than 0.1 wt.-% of water, based on the total weight of the solvent mixture. The solvent-borne coating composition may be completely free of water, i.e., the solvent-borne coating composition may comprise 0 wt.-% of water based on the total weight of the solvent mixture.

Moreover, the coating composition may be a water-borne coating composition. The term “water-borne coating composition” refers to a coating composition comprising a solvent mixture comprising water and less than 50 wt.-% of an organic solvent, such as less than 40 wt.-% of an organic solvent, such as less than 30 wt.-% of an organic solvent, such as less than 20 wt.-% of an organic solvent, such as less than 10 wt.-% of an organic solvent, such as less than 5 wt.-% of an organic solvent, such as less than 2 wt.-% of an organic solvent, such as less than 1 wt.-% of an organic solvent, based on the total weight of the solvent mixture. The water-borne coating composition may be free of an organic solvent, i.e., the water-borne coating composition may comprise less than 0.5 wt.-% of an organic solvent, such as less than 0.2 wt.-% of an organic solvent, such as less than 0.1 wt.-% of an organic solvent. The water-borne coating composition may be completely free of water, i.e., the water-borne coating composition may comprise 0 wt.-% of an organic solvent, based on the total weight of the solvent 2.5 mixture.

Alternatively, the coating composition may be a powdered coating composition. As used herein, the term “powdered coating composition” refers to a coating composition being in the form of solid particulates and substantially free of a solvent. The solid particulates may have a mean particle size in the rage of 2 μm 30 to 100 μm, such as 5 μm to 75 μm, or such as 10 μm to 50 μm, determined by dynamic light scattering according to DIN ISO 22412:2018-09. The term “substantially free” refers to a coating composition comprising less than 5 wt.-% of a solvent, such as less than 4 wt.-% of a solvent, such as less than 3 wt.-% of a solvent, such as less than 2 wt.-% of a solvent, such as less than 1 wt.-% of a solvent, based on the total weight of the coating composition. The powdered coating composition may be free of a solvent, i.e., the powder coating composition may comprise less than 0.5 wt.-% of a solvent, such as less than 0.2 wt.-% of a solvent, such as less than 0.1 wt.-% of a solvent, based on the total weight of the coating composition. The powdered coating composition may be completely free of a solvent, i.e., the powder coating composition may comprise 0 wt.-% of a solvent, based on the total weight of the coating composition.

The coating composition may further comprise an additional ingredient selected from colorants, such as pigments, dyes and tints; plasticizers; abrasion-resistant particles; anti-oxidants; hindered amine light stabilizers; UV light absorbers and stabilizers; surfactants; flow control agents; fillers; reactive diluents; catalysts; grind vehicles, such as an acrylic grind vehicle; defoamers; dispersants; adhesion promoters; antistatic agents; and mixtures thereof. When used, the coating composition may comprise a total of from 0.1 to 45 wt.-% of these additional ingredients, such as from 1 to 40 wt.-%, such as from 1.5 to 35 wt.-%, based on the total solids weight of the coating composition.

As used herein, the term “colorant” means any substance that imparts color and/or other opacity and/or other visual effect to the composition. The colorant can be added to the liquid or powder coating composition in any suitable form, such as discrete particles, dispersions, solutions and/or flakes. Examples of suitable pigments include, but are not limited to, carbazole dioxazine pigments, azo pigments, monoazo pigments, disazo pigments, naphthol AS pigments, salt type (lakes) pigments, benzimidazolone pigments, metal complex pigments, isoindolinone pigments, isoindoline pigments, polycyclic phthalocyanine pigments, quinacridone pigments, perylene pigments, perinone pigments, diketopyrrolo pyrrole pigments, thioindigo pigments, anthraquinone pigments, indanthrone pigments, anthrapyrimidine pigments, flavanthrone pigments, pyranthrone pigments, anthanthrone pigments, dioxazine pigments, triarylcarbonium pigments, quinophthalone pigments, diketo pyrrolo pyrrole red (“DPPBO red”), titanium dioxide, carbon black and mixtures thereof. Suitable dyes include, but are not limited to, acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Suitable plasticizers include, but are not limited to, phthalate esters, such as dibutylphthalate, butyl benzyl phthalate, diisooctyl phthalate and decyl butyl phthalate; chlorinated paraffins; and hydrogenated terphenyls.

As used herein, an “abrasion-resistant particle” is one that, when used in a coating, will impart some level of abrasion resistance to the coating as compared with the same coating lacking the particles. The abrasion-resistant particles may have a hardness value greater than the hardness value of materials that can abrade a coating. Examples of materials that can abrade a coating may include, but are not limited to, dirt, sand, rocks, glass, carwash brushes, and the like. The hardness value of the abrasion-resistant particles and the materials that can abrade the coating can be determined by any conventional hardness measurement method, such as Vickers or Brinell hardness, or can be determined according to the original Mohs' hardness scale which indicates the relative scratch resistance of the surface of a material on a scale of one to ten. The abrasion-resistant particles may have a Mohs' hardness value of greater than 5, such as greater than 6 and may have a Mohs' hardness value of at least 10, such as 9. Suitable abrasion resistant particles include organic and/or inorganic particles. Examples of suitable organic particles include but are not limited to diamond particles, such as diamond dust particles, and particles formed from carbide materials, such as titanium carbide, silicon carbide and boron carbide. Examples of suitable inorganic particles include, but are not limited to, silica, alumina, alumina silicate, silica alumina, alkali aluminosilicate, borosilicate glass, nitrides including boron nitride and silicon nitride, titanium dioxide, zirconium oxide, zinc oxide, quartz, nepheline syenite, buddeluyite, and eudialyte.

Suitable examples of anti-oxidants to, e.g., prevent oxidation of resins from heat exposure that extends from production and application or to prevent yellowing of the coating, include, but are not limited to, phenolic anti-oxidants, phosphite anti-oxidants and the like. Suitable anti-oxidants include, but are not limited to Irganox® antioxidants, such as Irganox 245, Irganox 1010, and Irganox 1076 commercially available from BASF SE (Germany).

As used herein, a “hindered amine light stabilizer” (“HALS”) refers to compounds comprising an amine functional group and which are added to polymeric materials to inhibit or retard their degradation by, e.g., photo-oxidation. Typically, derivatives of tertramethylpiperidine are used. Examples of suitable hindered amine light stabilizers (HALS) include, but are not limited to, Tinuvin® light stabilizers, such as TINUVIN® 292, TINUVIN® 123, TINUVIN® 328, TINUVIN® 622, TINUVIN® 783, and TINUVIN® 770 available from BASF (Germany). As used herein, “UV light absorbers and stabilizers” refer to compounds used to absorb UV radiation to reduce the UV degradation of a polymeric material. Examples of suitable UV light absorbers and stabilizers include, but are not limited to, CYASORB light stabilizers, such as CYASORB UV-1164L available from Solvay (Germany) and TINUVIN® 1130 available from BASF (Germany).

Surfactants may be added to the coating composition in order to aid, e.g., in flow and wetting of the substrate. Suitable surfactants include, but are not limited to alkyl sulphates (e.g., sodium lauryl sulphate); ether sulphates; phosphate esters; sulphonates; and their various alkali, ammonium, and amine salts; aliphatic alcohol ethoxylates; alkyl phenol ethoxylates (e.g., nonyl phenol polyether); salts and/or combinations thereof.

As used herein, the term “flow control agent” refers to a compound, which controls the rheological behavior of the coating composition during application, drying and/or curing, including controlling viscosity, thixotropic properties under shear stress and leveling when applied to a surface of a substrate. The flow control agent may comprise sag control agents. As used herein, the term “sag control agent” refers to a compound which minimizes sagging, i.e., defects such as tear drops caused by gravity-driven flow of wet coating compositions when applied to a substrate, in particular a substrate comprising a non-horizontal, e.g., a vertical surface. Suitable flow control agents, especially sag control agents may include, but are not limited to those compounds described in U.S. Pat. No. 4,311,622 A, EP 0 192 304 A1 and EP 3 728 482 A1.

As used herein, a “reactive diluent” refers to a monomer or oligomer which reduces the viscosity of the coating composition and can be co-polymerized during curing of the coating composition. A suitable reactive diluent may have a molecular weight in the range of 100 to 350 g/mol. Suitable examples of reactive diluents include, but are not limited to, epoxy functional compounds, vinyl functional compounds, (meth) acrylate compounds, and combinations thereof.

The coating compositions may contain a catalyst to facilitate any desired curing reaction. Any curing catalyst typically used to catalyze crosslinking reactions may be used, and there are no particular limitations on the catalyst. Non-limiting examples of catalysts include phenyl acid phosphate, sulfonic acid functional catalysts such as dodecylbenzene sulfonic acid (DDBSA), dinonyl naphthalene sulfonic acid, dinonyl naphthalene disulfonic acid, complexes of organometallic compounds including tin, zinc or bismuth, such as stannous octoate, butyl stannoic acid, dibutyltin dilaurate (DBTL), dibutyltin diacetate, dibutyltin mercaptide, dibutyltin diacetate, dibutyltin dimaleate, dimethyltin diacetate, dimethyltin dilaurate, 1,4-diazabicyclo [2.2.2] octane and bismuth carboxylates, and the like.

Alternatively, the coating compositions may be essentially free of a catalyst. As used throughout this specification, including the claims, by “essentially free” is meant that a compound is not intentionally present in the coating composition; and if a compound is present in the coating composition, it is present incidentally in an amount less than 0.1 wt.-%, usually less than trace amounts, i.e., in an amount less than 100 ppm, based on the total weight of the coating composition.

As used herein, the term “adhesion promoter” refers to any material that, when included in the coating composition, enhances the adhesion of the coating composition to a substrate in comparison to suitable examples of an adhesion promoter include, but are not limited to, a free acid, a phosphatized epoxy resin or an alkoxysilane. As used herein, the term “free acid” is meant to encompass organic and/or inorganic acids that are included as a separate component of the compositions as opposed to any acids that may be used to form a polymer that may be present in the composition. The free acid may comprise tannic acid, gallic acid, phosphoric acid, phosphorous acid, citric acid, malonic acid, a derivative thereof, or a mixture thereof. Suitable derivatives include esters, amides, and/or metal complexes of such acids.

The coating composition can be applied to a part of a surface of a substrate by any means standard in the art, such as by electrocoating, spraying, electrostatic spraying, dipping, rolling, brushing, and the like. The coating composition can be applied to a part of a surface of the substrate to obtain a dry coating thickness of at least 1 μm, such as of at least 10 μm, or of at least 20 μm, or of at least 30 μm, or of at least 40 μm, or of at least 50 μm. The coating composition can be applied to a part of a surface of the substrate to obtain a dry coating thickness of 1500 μm or less, such as of 1300 μm or less, or of 1000μm or less, or of 800 μm or less, or of 500 μm or less. The coating composition can be applied to a part of a surface of the substrate to obtain a dry coating thickness in a range between any of the above-mentioned values such as from 1 to 1500 μm, such as from 10 to 1300 μm, such as from 20 to 1000 μm, such as from 30 to 800 μm, such as from 50 to 500 μm. The thickness can be determined according to DIN EN ISO 2178:2016. As used herein, the “dry coating thickness” is the thickness of a coating, which is applied to a part of a surface of a substrate, measured above the substrate after the coating is cured.

The coating composition can be applied to a wide range of substrates, known in the coatings industry. For example, the substrate, specifically a part of the surface of the substrate, to which the coating composition is applied can comprise a material selected from metals, plastics, ceramics, such as boron carbide or silicon carbide, glass, wood, paper, cardboard, rubber, leather, textiles, fiberglass composite, carbon fiber composite, an existing coating, or mixtures thereof.

Metals may include, but are not limited to, ferrous metals, tin steel, aluminum, aluminum alloys, zinc-aluminum alloys, titanium, titanium alloys, magnesium, magnesium alloys, copper, copper alloys and mixtures. The ferrous metal may include iron, steel, and alloys thereof. Non-limiting examples of useful steel materials may include rolled steel, galvanized (zinc coated) steel, electrogalvanized steel, stainless steel, pickled steel, zinc-iron alloy, and combinations thereof. Combinations or composited of ferrous and non-ferrous metals can also be used. Aluminum alloys of the 1XXX, 2XXX, 3XXX, 4XXX, 5XXX, 6XXX, 7XXX or 8XXX series as well as clad aluminum alloys and cast aluminum alloys of the A356, 1XX.X, 2XX.X, 3XX.X, 4XX.X, 5XX.X, 6XX.X, 7XX.X or 8XX.X series also may be used as the substrate. Magnesium alloys of the AZ31B, AZ91C, AM60B or EV31A series also may be used as the substrate. The substrate may be pretreated with pretreatment solution including a zinc phosphate pretreatment solution such as, e.g., those described in U.S. Pat. No. 4,793,897 and U.S. Pat. No. 5,588,989, or a zirconium containing pretreatment solution such as, e.g., those described in U.S. Pat. No. 7,749,368and 8,673,091.

The coating composition of the present disclosure may be a primer coating composition and/or a basecoat composition and/or a top coat composition. Moreover, the coating composition may be a clear coat composition and/or a colored coating composition. Optionally, the coating composition of the present disclosure may be a clear coat composition.

The coating composition may be a one-component (1K) coating composition or a two-part (2K) coating composition. Suitably, the coating composition of the present disclosure may be a one-component (1K) coating composition. As used herein, a “one-component” or “1K” coating composition is a composition in which all the ingredients may be premixed and stored in one container and wherein the reactive components do not readily react at ambient temperatures, e.g., temperatures in the range of from 20 to 25° C., or slightly elevated temperatures, e.g., temperatures in the range of 25° to 60° C., but instead only react upon activation by an external energy source. External light source that may be used to promote the curing reaction include, for example, radiation (i.e., actinic radiation) and/or heat. As used herein, a “two-component” or “2K” coating composition is a composition in which at least a portion of the reactive components readily react and at least partially cure without activation from an external energy source, such as at ambient temperatures, e.g., temperatures in the range of from 20 to 25° C., or slightly elevated temperatures, e.g., temperatures in the range of 25° to 60° C., when mixed. One of skill in the art understands that the two components of the coating composition are stored separately from each other and mixed just prior to application of the coating composition.

As mentioned above, in the method of the present disclosure the coating composition is cured by applying pulsed infrared radiation having a peak wavelength in the range of from 3 μm to 10 μm at a pulse duration of less than 100 μs to the coating composition, which is applied to a part of a surface of a substrate. As used herein, the term “pulsed” refers to radiation that is emitted in time-limited portions (the pulses). The term “infrared radiation” refers to electromagnetic radiation having a wavelength in the range of 780 nm to 1 mm. Accordingly, the term “pulsed infrared radiation” refers to electromagnetic radiation having a wavelength in the infrared spectral range, which is applied in pulses. The pulses may have a pulse duration at a pulse frequency.

The terms “cure”, “cured” or similar terms, as used in connection with the coating composition described herein, means that at least a portion of the components that form the coating composition is crosslinked to form a coating. The pulsed infrared radiation may be applied to the coating composition to form an at least partially cured coating. As used herein, the term “at least partially cured coating” means that the reaction of at least a portion of the reactive groups of the components of the coating composition occurs. According to the present disclosure, the pulsed infrared radiation may be applied to the coating composition to form a full cured coating. Full cure is attained when further curing results in no significant further improvement in the coating properties. Cure, or the degree of cure, can also be determined by dynamic mechanical thermal analysis (DMTA) using a Polymer Laboratories MK III DMTA analyzer conducted under nitrogen in which the degree of cure can for example be at least 10%, such as at least 30%, such as at least 50%, such as at least 70%, or at least 90% of complete crosslinking as determined by DMTA.

According to the present disclosure, full cure of the coating composition can be achieved by applying the pulsed infrared radiation for a time of less than 30 min, or less than 25 min, or less than 20 min, or less than 15 min, or less than 10 min. According to the present disclosure, full cure of the coating composition can be achieved by applying the pulsed infrared radiation for a time of at least 2 min, or at least 4 min, or at least 5 min, or at least 6 min, or at least 8 min. Full cure of the coating composition can be achieved by applying the pulsed infrared radiation in a range between any of the above-mentioned values such as from 2 min to 30 min, such as from 4 min to 25 min, such as from 5 min to 20 min, such as from 6 to 15 min, such as from 8 min to 10 min. In comparison with curing coating compositions in an oven, shorter curing times can be achieved resulting in energy savings. The method further provides high efficiency, as the infrared radiators are active shortly after switching on, without a long preheating period, and only desired partial areas are heated, e.g., the substrate having applied the coating composition.

Using pulsed infrared radiation, the transfer of energy to the coating composition is not primarily realized by thermal convection or thermal conduction, but by non-visible electromagnetic waves in the infrared spectral range at the speed of light, because electromagnetic waves propagate in the same way and at the same speed as light waves. Infrared radiation penetrates quickly and effectively into the surface of the substrate and ensures rapid curing of the applied coating composition. This enables the transfer of a radiation with high energy density and thus an energetically highly efficient curing of the coating composition according to the present disclosure. Faster and more energy-efficient curing at low temperatures can be achieved. In addition to accelerated curing, the use of pulsed infrared radiation according to the present disclosure may impart enhanced physical and/or chemical properties to the cured coating formed from the coating composition according to the present disclosure.

The enhanced physical and/or chemical properties may include microhardness, scratch resistance, mar resistance, and/or chemical resistance towards acids, enzymes, tree sap, or a combination thereof. As used herein, the term “microhardness” refers to the resistance of a material to undergo permanent deformation when a low force is applied, e.g., a force in the range from 0.01 N to 10 N. Microhardness may be determined according to DIN EN ISO 14577-1. As used herein, the term “scratch and mar resistance” refers to the resistance of a material to damage from impact, rubbing or abrasion that produces visible scratches or marring. Scratch and mar resistance may be determined according to DIN EN ISO 20566:2021 and DIN EN ISO 21546:2021. As used herein, the term “chemical resistance” refers to the resistance of a material to the effects of chemicals, such as, e.g., discoloration, alteration in the degree of shine, softening, swelling, detachment of coatings or blistering. Chemical resistance towards acids, enzymes, tree sap, or a combination thereof may be determined according to DIN EN ISO 2812-5:2018.

According to the present disclosure, the surface temperature of the substrate during applying the pulsed infrared radiation in step (ii) to the applied coating composition to form a cured coating can be less than 130° C. or less than 120° C. According to the present disclosure, the surface temperature of the substrate during applying the pulsed infrared radiation in step (ii) to the applied coating composition to form a cured coating can be at least 90° C. The surface temperature of the substrate during applying the pulsed infrared radiation in step (ii) to the applied coating composition to form a cured coating can be in the range of from 90° C. to 130° C., such as from 90° C. to 120° C. The surface temperature of the substrate may be determined according to DIN EN 60584-1:2016.

According to the present disclosure, the pulsed infrared radiation is applied having a peak wavelength in the range of from 3 μm to 10 μm to the applied coating composition. As used herein, the term “peak wavelength” refers to the maximum emission wavelength of the pulsed infrared radiation. The pulsed infrared radiation used in the methods of the present disclosure may have a peak wavelength of 6 μm or less, or of 4 μm or less. The pulsed infrared radiation may be in the range of from 3 μm to 6 μm or of from 3 μm to 4 μm.

According to the present disclosure, the pulsed infrared radiation is applied at a pulse duration of less than 100 μm to the applied coating composition. As used herein, the term “pulse duration” which is also referred to as “pulse width”, refers to the full-width at half maximum (FWHM) amplitude of a pulse of the pulsed infrared radiation. According to the present disclosure, the pulsed infrared radiation can be applied at a pulse duration of at least 5 μs, such as at least 7 μs, or at least 8 μs, or at least 10 μs. The pulsed infrared radiation can be applied at a pulse duration of 75 μs or less, such as 50 μs or less, or 25 μs or less, or 17 μs or less, or 14 μs or less. The pulsed infrared radiation can be applied at a pulse duration ranging from 7 μs to 14 μs, or from 8 μs to 14 μs, or from 10 μs to 14 μs, or from 7 μs to 17 μs, or from 8 μs to 17 μs, or from 10 μs to 17 μs, or from 7 μs to 25 μs, or from 8 μs to 25 μs, or from 10 μs to 25 μs, or from 7 μs to 50 μs, or from 8 μs to 50 μs, or from 10 μs to 50 μs, or from 7 μs to 75 μs, or from 8 μs to 75 μs, or from 10 μs to 75 μs. According to the present disclosure, the pulsed infrared radiation can be applied at a pulse duration in a range between any of the above-mentioned values such as from 7 μs to 75 μs, such as from 7 μs to 50 μs, such as from 8 μs to 25 μs, such as from 10 μs to 17 μs, such as from 10 μs to 14 μs.

As used herein, the term “pulse frequency” refers to the number of pulses per second of the pulsed infrared radiation. The pulsed infrared radiation according to the present disclosure can be applied at a pulse frequency of at least 350 Hz, such as at least 370 Hz, or at least 390 Hz, or at least 400 Hz. The pulsed radiation according to the present disclosure can be applied at a pulse frequency of 450 Hz or less, such as 430 Hz. The pulsed infrared radiation can be applied at a pulse frequency in the range of from 350 Hz to 450 Hz, such as from 350 Hz to 430 Hz, or from 370 Hz to 450 Hz, or from 370 Hz to 430 Hz, or from 390 Hz to 450 Hz, or from 390 Hz to 430 Hz, or from 400 Hz to 450 Hz, or from 400 Hz to 430 Hz. According to the present disclosure, the pulsed infrared radiation can be applied at a pulse frequency in the range of from 350 Hz to 450 Hz, such as from 370 Hz to 450 Hz, such as from 390 Hz to 430 Hz, such as from 390 Hz to 430 Hz.

As used herein, the term “impulse energy” refers to the total radiant power of electromagnetic radiation received by a surface per unit area. The pulsed infrared radiation according to the present disclosure can be applied at an impulse energy of at least 250 W/cm², such as at least 270 W/cm², or at least 290 W/cm². The pulsed radiation according to the present disclosure can be applied at an impulse energy of 350 W/cm² or less, such as 330 W/cm² or less, or 320 W/cm² or less. The pulsed infrared radiation can be applied at an impulse energy in the range between any of the above-mentioned values such as from 250 W/cm² to 350 W/cm², or from 250 W/cm² to 330 W/cm², or from 250 W/cm² to 320 W/cm², or from 270 W/cm² to 350 W/cm², or from 270 W/cm² to 330 W/cm², or from 270 W/cm² to 320 W/cm², or from 290 W/cm²to 350 W/cm², or from 290 W/cm² to 330 W/cm², or from 290 W/cm² to 320 W/cm².

According to the disclosure, the pulsed infrared radiation may be provided by an infrared light source comprising a surface which comprises a ceramic composition. The ceramic composition can be capable of absorbing heat and emitting infrared radiation having a peak wavelength in the range of from 3 μm to 10 μm. According to the present disclosure, an infrared light source may comprise a surface which comprises a ceramic composition capable of absorbing heat and emitting infrared radiation having a peak wavelength in the range of from 3 μm to 10 μm. Using of pulsed infrared radiation generated by the ceramic compositions may provide a positive impact on curing of the coating composition according to the present disclosure.

For curing, the infrared radiation emitting surface of the infrared light source may face the surface of the substrate having applied the coating composition to be cured. Herein, the distance between the infrared emitting surface of the infrared light source and the surface of the substrate having applied the coating composition to be cured may be at a distance of at least 5 cm, such as at least 10 cm, or at least 15 cm. Herein, the distance between the infrared emitting surface of the infrared light source and the surface of the substrate having applied the coating composition to be cured may be at a distance of 50 cm or less, such as 45 cm or less, or 40 cm or less, or 35 cm or less, or 30 cm or less, or 25 cm or less. The infrared radiation emitting surface of the infrared light source can face the surface of the substrate having applied the coating composition to be cured at a distance in a range between any of the above-mentioned values such as from 5 cm to 30 cm or from 15 cm to 25 cm.

According to the present disclosure, the infrared light source may face the surface of the substrate having applied the coating composition to be cured at least from one side. At least one or more infrared light source(s) of the present disclosure may surround the substrate having applied the coating composition to be cured at least from one side. Suitable arrangements of the infrared light source are described, for example, in EP 1 690 842 A1 (especially in paragraphs to)

and WO 2011/015164 (especially on page 12 to 13). The infrared light source according to the present disclosure may have any desired shape, such as a shape of a rod, a tube, a flat plate or a curved plate.

The infrared light source may further comprise a heat source for directly or indirectly heating up the ceramic composition. Heat transfer from the heat source may include various ways of heat transfer, including radiation transfer, convection, contact transfer or a transfer via thermally conductive materials in between the heat source and the ceramic composition. The infrared light source may further comprise a carrier material for heat absorption and/or heat transfer from the heat source to the ceramic composition. The carrier material may comprise one or more of the following materials: Fe; SiO₂; 3Al₂O₃.2SiO₂ and/or 2Al₂O₃.1SiO₂ (mullite); Al or Cu. Further, the infrared light source may comprise a reflector device. The ceramic composition may generate infrared light and emit the infrared light, inter alia, into an unwanted direction. The reflector device, which may comprise one or more reflectors, may be applied to reflect the infrared light emitted in unwanted directions and re-direct said infrared light in a certain area, e.g., to the surface of the substrate having applied the coating composition to be cured.

The ceramic composition according to the present disclosure may comprise (a) a metal oxide component comprising (a-i) a metal element selected from the group consisting of alkaline earth elements, transition metal elements, the lanthanides and actinides, and (a-ii) oxygen; and (b) a mullite remainder component comprising 3Al₂O₃.2SiO₂ and/or 2Al₂O₃.SiO₂ (mullite). Suitable examples of a metal oxide component (a) include, but are not limited to, Cr₂O₃, ZrO₂, Ho₂O₃, Fe₂O₃, LaCrO₃, CeO₂, Y₂O₃, YCrO₃, Gd₂O₃, MgAl₂O₄, MgCrO₄, CaCrO₄, YCrO₃, CuO, La₂O₃, CuCrO₄ and FeCrO₃. The ceramic composition may consist of a metal oxide component (a) and a mullite remainder component (b).

The ceramic composition can comprise at least 0.1 wt.-% of the metal oxide component (a), such as at least 0.5 wt.-%, such as at least 1.0 wt.-%, such as at least 5.0 wt.-%, based on the total weight of the ceramic composition. The ceramic composition can comprise 70.0 wt.-% or less of the metal oxide component (a), such as 60.0 wt.-% or less, such as 50.0 wt.-% or less, such as 40.0 wt.-% or less, such as 30.0 wt.-% or less such as 20.0 wt.-% or less, based on the total weight of the ceramic composition. The ceramic composition can comprise the metal oxide component (a) in a range of from 0.1 to 70.0 wt.-%, or from 0.5 to 70.0 wt.-%, or from 1.0 to 70.0 wt.-%, or from 5.0 to 70.0 wt.-%, or 0.1 to 60.0 wt.-%, or 0.5 to 60.0 wt.-%, or 1.0 to 60.0 wt.-%, or 5.0 to 60.0 wt.-%, or 0.1 to 50.0 wt.-%, or 0.5 to 50.0 wt.-%, or 1.0 to 50.0 wt.-%, or 5.0 to 50.0 wt.-%, or 0.1 to 40.0 wt.-%, or 0.5 to 40.0 wt.-%, or 1.0 to 40.0 wt.-%, or 5.0 to 40.0 wt.-%, or 0.1 to 30.0 wt.-%, or 0.5 to 30.0 wt.-%, or 1.0 to 30.0 wt.-%, or 5.0 to 30.0 wt.-%, or 0.1 to 20.0 wt.-%, or 0.5 to 20.0 wt.-%, or 1.0 to 20.0 wt.-%, or 5.0 to 20.0 wt.-%, based on the total weight of the ceramic composition. According to the present disclosure, the ceramic composition can comprise the metal oxide component (a) in a range of from 0.1 to 70.0 wt.-%, such as from 0.5 to 60.0 wt.-%, such as from 0.5 to 50.0 wt.-%, such as from 1.0 to 40.0 wt.-%, such as from 1.0 to 30.0 wt.-%, such as from 5.0 to 20.0 wt.-%, based on the total weight of the ceramic composition.

The ceramic composition can comprise at least 30.0 wt.-% of the mullite remainder component (b), such as at least 40.0 wt.-%, such as at least 50.0 wt.-%, such as at least 60.0 wt.-%, such as at least 70.0 wt.-%, such as at least 80.0 wt.-%, based on the total weight of the ceramic composition. The ceramic composition can comprise 99.9 wt.-% or less of the mullite remainder component (b), such as 99.5 wt.-% or less, such as 99.0 wt.-% or less, such as 95.0 wt.-% or less, based on the total weight of the ceramic composition. The ceramic composition can comprise the mullite remainder component (b) in a range of from 30.0 to 99.9 wt.-%, or from 30.0 to 99.5 wt.-%, or from 30.0 to 99.0 wt.-%, or from 30.0 to 95.0 wt.-%, or from 40.0 to 99.9 wt.-%, or 40.0 to 99.5 wt.-%, or 40.0 to 99.0 wt.-%, or 40.0 to 95.0 wt.-%, or 50.0 to 99.9 wt.-%, or 50.0 to 99.5 wt.-%, or 50.0 to 99.0 wt.-%, or 50.0 to 95.0 wt.-%, or 60.0 to 99.9 wt.-%, or 60.0 to 99.5 wt.-%, or 60.0 to 99.0 wt.-%, or 60.0 to 95.0 wt.-%, or 70.0 to 99.9 wt.-%, or 70.0 to 99.5 wt.-%, or 70.0 to 99.0 wt.-%, or 70.0 to 95.0 wt.-%, or 80.0 to 99.9 wt.-%, or 80.0 to 99.5 wt.-%, or 80.0 to 99.0 wt.-%, or 80.0 to 95.0 wt.-%, based on the total weight of the ceramic composition. According to the present disclosure, the ceramic composition can comprise the mullite remainder component (b) in a range of from 30.0 to 99.9 wt.-%, or from 40.0 to 99.9 wt.-%, or from 50.0 to 99.5 wt.-%, or from 60.0 to 99.0 wt.-%, or from 70.0 to 95.0 wt.-%, or 80.0 to 95.0 wt.-%, based on the total weight of the ceramic composition.

The ceramic compositions can be processed by standard ceramic processing procedure known to a person skilled in the art. The ceramic composition according to the present disclosure may be milled by conventional milling procedures, such as arc milling, to a fine powder, mixed until homogeneity is achieved, and melted, typically at temperatures of 2.600° C. The melting may be carried out in an oxidizing atmosphere, e.g., in air. The resulting melted material may be ground to a grain size, e.g., in the range of 100 to 250 μm and then the powder may be formed into a desired shape. A suitable procedure of processing ceramic compositions is disclosed in, e.g., WO 99/01401 A1. The process of forming the ceramic composition may include high-pressure treatment of the ceramic composition using a press and shaping a formed body of the object to be generated of the ceramic composition. The process of shaping the ceramic composition into an object may further include further temperature treatments, such as sintering process, and, optionally, further pressurizing processes.

Shaping of the ceramic compositions to form arbitrary objects may include standard shaping procedures, such as mechanical treatment, powder processes, or ceramic injection molding. Thus, the ceramic composition can be formed by standard ceramic forming procedures into nearly arbitrary shape.

The present disclosure further relates to a coated substrate obtained by the method according to the method described above. The coated substrate can be vehicles, storage tanks, windmills, packaging substrates, wood flooring and furniture, apparel, electronics, glass and transparencies, sports equipment, buildings, bridges, and the like. According to the present disclosure, the coated substrate of the present disclosure can be a vehicle part.

The term “vehicle” is used in its broadest sense and includes (without limitation) all types of aircraft, spacecraft, watercraft, and ground vehicles. For example, a vehicle can include, aircraft such as airplanes including private aircraft, and small, medium, or large commercial passenger, freight, and military aircraft; helicopters, including private, commercial, and military helicopters; aerospace vehicles including, rockets and other spacecrafts. Vehicles can include ground vehicles such as, for example, trailers, cars, trucks, buses, coaches, vans, ambulances, fire engines, motorhomes, caravans, go-karts, buggies, fork-lift trucks, sit-on lawnmowers, agricultural vehicles such as, for example, tractors and harvesters, construction vehicles such as, for example, diggers, bulldozers and cranes, golf carts, motorcycles, bicycles, trains, and railroad cars. Vehicles can also include watercraft such as, for example, ships, submarines, boats, jet-skis and hovercraft.

Parts of vehicles coated in accordance with the present disclosure may include vehicular body parts (e.g., without limitation, doors, body panels, trunk deck lids, roof panels, hoods, roofs and/or stringers, rivets, wheels, landing gear components, and/or skins used on an aircraft), hulls, marine superstructures, vehicular frames, chassis, and vehicular parts not normally visible in use, such as engine parts, motorcycle fairings and fuel tanks, fuel tank surfaces and other vehicular surfaces exposed to or potentially exposed to fuels, aerospace solvents and aerospace hydraulic fluids. Any vehicular parts which may benefit from coating as defined herein may undergo coating, whether exposed to or hidden from view in normal use.

Further, the present disclosure relates to use of a coating composition according to the present disclosure comprising a film-forming resin and a crosslinking agent suitable for crosslinking the film forming resin in methods of curing a coating composition by applying pulsed infrared radiation having a peak wavelength in the range of from 1 μm to 10 μm, such as 3 μm to 10 μm, at a pulse duration of less than 100 μs to the coating.

The present disclosure also relates to use of pulsed infrared radiation having a peak wavelength in the range of from 1 μm to 10 μm, such as 3 μm to 10 μm, to enhance the physical and/or chemical properties of a cured coating formed from a 1K coating composition according to the present disclosure comprising a film-forming resin and a crosslinking agent suitable for crosslinking the film forming resin to a part of a surface of the substrate.

The enhanced physical and/or chemical properties may include microhardness, scratch resistance, mar resistance, and/or chemical resistance towards acids, enzymes, tree sap, or a combination thereof. Microhardness, scratch and mar resistance as well as chemical resistance can be determined as discussed above.

As used herein, unless otherwise expressly specified, all numbers such as those expressing values, ranges, amounts or percentages may be read as if prefaced by the word “about”, even if the term does not expressly appear.

The following examples are intended to illustrate the disclosure and should not be construed as limiting the disclosure in any way.

### EXAMPLES

### Preparation of Coating Compositions

One-component (1K) coating composition

A clear coat coating composition according to the present disclosure was prepared by mixing the components listed in Table 1 under agitation.

TABLE 1
1K coating composition

| Component | Parts per weight [%] |
|---|---|
| Acrylic resin¹ | 13.27 |
| Acrylic resin² | 14.30 |
| Melamine resin³ | 20.00 |
| Anti-oxidant⁴ | 0.20 |
| Flow control agent⁵ | 0.02 |
| HALS⁶ | 0.50 |
| UV light absorber⁷ | 1.20 |
| Catalyst⁸ | 1.20 |
| Sag control agent⁹ | 27.50 |
| Conductivity additive¹⁰ | 0.21 |
| Solvent¹¹ | 21.6 |

¹Hydroxy value: 150, OH %: 4.55, Solid content: 64.5, Tg [° C.]: 15
²Hydroxy value: 115, OH %: 3.48, Solid content: 69, Tg [° C.]: −27
³Setamine US-146 BB-42 commercially available from Allnex (Germany)
⁴Irganox 1010 commercially available from BASF (Germany)
⁵BYK-378 commercially available from Byk (Germany)
⁶Tinuvin 292 commercially available from BASF (Germany)
⁷Tinuvin 1130 commercially available from BASF (Germany); Eversorb 80 commercially available from Everlight Chemical (Taiwan); Chiguard 5530 commercially available from Chitec Technology (Taiwan)
⁸Nacure 5528 commercially available from King Industries Inc. (USA)
⁹Setalux 91756 commercially available from Allnex (Germany)
¹⁰Efka ® MI 6779 from BASF
¹¹Aromatic 100 commercially available from ExxonMobil (USA); isotridecyl alcohol; diethylene glycol monobutyl ether; 2-butoxyethyl actetate, ethyl 3-ethoxypropionate; diethylene glycol butyl ether acetate

The hydroxyl value and the hydroxy content (OH %) of the acrylic resins was determined according to DIN EN ISO 4629-1:2016. The glass transition temperature (Tg) was determined according to DIN EN ISO 16805/2005.

### Two-Component (2K) Coating Composition

A 2K clear coat coating composition according to the present disclosure were prepared by preparing Component A and Component B as listed in Table 2.

TABLE 2
2K Coating composition

| | Parts per weight [%] |
|---|---|
| Component A | |
| Acrylic resin¹ | 41.65 |
| Polyester resin² | 2.75 |
| Melamine resin³ | 4.22 |
| UV light absorber⁴ | 4.31 |
| HALS⁵ | 0.59 |
| Flow control agent⁶ | 2.60 |
| Defoamer⁷ | 0.06 |
| Catalyst⁸ | 1.44 |
| Sag control agent⁹ | 22.00 |
| Solvent¹⁰ | 20.38 |
| Component B | |
| Polyisocyanate¹¹ | 86.70 |
| Solvent¹² | 13.30 |

¹Hydroxyl number: 150, OH %: 4.55, Solid content: 60, Tg [° C.]: −5
²Hydroxyl number: 290, OH %: 8.79, Solid content: 78, Tg [° C.]: −16
³Cymel 1156 commercially available from Allnex (Germany)
⁴Tinuvin 928 commercially available from BASF (Germany)
⁵Tinuvin 123 commercially available from BASF (Germany)
⁶Byk 322 commercially available from Byk (Germany);
⁷Byk 390 commercially available from Byk (Germany)
⁸Nacure 5528 commercially available from King Industries Inc. (USA)
⁹Setalux 91767 VX-60 commercially available from Allnex (Germany)
¹⁰Aromatic 100 commercially available from ExxonMobil (USA); isoamyl actetate, n-butylacetate; ethyl 3-ethoxypropionate; diethylene glycol butyl ether acetate, 2-butoxyethyl acetate
¹¹Desmodur ultra N 3390 BA/SN commercially available from Covestro (Germany)
¹²Solesso 100 commercially available from ExxonMobil (USA)

The hydroxyl value and the hydroxy content (OH %) of the acrylic resins was determined according to DIN EN ISO 4629-1:2016. The glass transition temperature (Tg) was determined according to DIN EN ISO 16805:2005.

### Coating of Substrate

The 1K coating composition and the 2K coating composition after mixing Component A and Component B of Table 2 were spray applied with a Satajet 100BFRP spray gun available from SATA GmbH&Co (Germany) onto E-coated steel substrates available from ACT Test Panels LLC (USA). The film thickness of the coating composition ranges between 45 and 55 μm determined according to DIN EN ISO 2178:2016.

### Curing of Coated Substrates Using Pulsed Infrared Radiation

The substrates coated with the coating composition shown in Table 1 and Table 2 were cured using the pulsed infrared light source IR.X Infrarot Modul D2 commercially available from SPS Group GmbH (Germany). The pulsed infrared light source was facing the substrate having applied the coating composition to be cured at a distance of 20 cm. The following settings shown in Table 3 were applied.

TABLE 3

| | | |
|---|---|---|
| Peak wavelength | 3-4 | μm |
| Pulse duration | 12 | μs |
| Impulse energy | 320 | W/cm² |
| Cure temperature | 100-120° | C. |

The substrates were cured for 10 min, 15 min and 20 min.

### Conventional Curing of Coated Substrates Using an Oven

The substrates coated with the coating composition shown in Table 2 were cured using heated air in an oven (HORO Dr. Hofmann GmbH (Germany)). The substrates were cured at 140° C. for 30 min.

### Measurement of Properties of the Cured Coatings

Microhardness of the cured coatings was determined according to DIN EN ISO 14577-1. Chemical resistance of the cured coatings was determined according to DIN EN ISO 2812-5:2018. Scratch resistance of the cured coatings simulating a car wash system was measured according to DIN EN ISO 20566:2021. Scratch resistance using a linear abrasion tester (crockmeter) was determined according to DIN EN ISO 21546:2021. In Table 4 and Table 5, the properties of the cured coatings were summarized.

TABLE 4
Properties of cured coating of 1K coating composition

| Property | Pulsed infrared radiation | | | Oven |
|---|---|---|---|---|
| Time [min] | 4 | 6 | 8 | 30 |
| Microhardness [N/mm²] | 21 | 66 | 68 | 52 |
| Residual gloss¹ [%] | n. t. | n. t. | 81 | 62 |
| 10 cycle crockmeter | | | | |
| Residual gloss² [%] after | n. t. | n. t. | 74 | 75 |
| 10x carwash | | | | |
| Residual gloss² [%] after | n. t. | n. t. | 66 | 53 |
| 20x carwash | | | | |
| Residual gloss² [%] after | n. t. | n. t. | 59 | 33 |
| 30x carwash | | | | |
| Chemical resistance³ | n. t. | n. t. | 43 | 39 |
| H₂SO₄ [° C.] | | | | |
| Chemical resistance³ | n. t. | n. t. | 61 | 67 |
| NaOH [C] | | | | |
| Chemical resistance³ | n. t. | n. t. | 54 | 40 |
| pancreatin [° C.] | | | | |
| Chemical resistance³ | n. t. | n. t. | 46 | 32 |
| treesap [C] | | | | |
| Chemical resistance³ | n. t. | n. t. | 53 | 54 |
| H₂O [° C.] | | | | |

¹determined according to DIN EN ISO 21546:2021;
²determined according to DIN EN ISO 20566:2021;
³determined according to DIN EN ISO 2812-5:2018;
n. t.: not tested

From Table 4, it can be seen that higher microhardness within a shorter curing time and at lower cure temperature can be achieved when using pulsed infrared radiation in comparison to conventional curing in an oven. In addition, microhardnesses are achieved that cannot be obtained by curing in the oven even through longer curing times. Moreover, better scratch and mar resistance as well as better chemical resistance are achieved.

TABLE 5
Properties of cured coating of 2K coating composition

| Property | Pulsed infrared radiation | | | Oven |
|---|---|---|---|---|
| Time [min] | 10 | 15 | 20 | 30 |
| Microhardness [N/mm²] | 74 | 83 | 96 | 92 |
| Residual gloss¹ [%] | 65 | n. t. | n. t. | 75 |
| 10 cycle crockmeter | | | | |
| Residual gloss² [%] after | 81 | n. t. | n. t. | 86 |
| 10x carwash | | | | |
| Residual gloss² [%] after | 65 | n. t. | n. t. | 73 |
| 20x carwash | | | | |
| Residual gloss² [%] after | 52. | n. t. | n. t. | 60 |
| 30x carwash | | | | |
| Chemical resistance³ | 44 | n. t. | n. t. | 45 |
| H₂SO₄ [° C.] | | | | |
| Chemical resistance³ | 49 | n. t. | n. t. | 57 |
| NaOH [C] | | | | |
| Chemical resistance³ | 36 | n. t. | n. t. | 36 |
| pancreatin [° C.] | | | | |
| Chemical resistance³ | 37 | n. t. | n. t. | 38 |
| treesap [° C.] | | | | |
| Chemical resistance³ | 60 | n. t. | n. t. | 64 |
| H₂O [° C.] | | | | |

¹determined according to DIN EN ISO 21546:2021;
²determined according to DIN EN ISO 20566:2021;
³determined according to DIN EN ISO 2812-5.2018;
n. t.: not tested

From Table 5, it can be seen that higher microhardness within a shorter curing time and at lower cure temperature can be achieved when using pulsed infrared radiation in comparison to conventional curing in an oven. In addition, comparable scratch and mar resistance as well as chemical resistance are achieved.

1. A method for coating a substrate comprising:
(i) applying a coating composition to a part of a surface of the substrate, wherein the coating composition comprises a film-forming resin and a crosslinking agent suitable for crosslinking the film-forming resin; and
(ii) applying pulsed infrared radiation having a peak wavelength in the range of from 3 μm to 10 μm at a pulse duration of less than 100 μs to the applied coating composition to form a cured coating.

2. The method of claim 1, wherein the coating composition is a solvent-borne coating composition, a water-borne coating composition or a powdered coating composition.

3. (canceled)

4. The method of claim 1, wherein the film-forming resin comprises an acrylic resin, a vinylic resin, a polyester resin, a polysiloxane resin, an epoxy resin, a polyurethane resin, a polyamide resin, a copolymer thereof or a mixture thereof.

5. The method of claim 1, wherein the crosslinking agent comprises a polyepoxide, a polyisocyanate, an amino resin, or a mixture thereof.

6. The method of claim 1, wherein the film-forming resin comprises an acrylic polyol resin.

7. (canceled)

8. The method of claim 1, wherein the coating composition is a 1K coating composition.

9. The method of claim 1, wherein the coating composition is a clear coat composition.

10. The method of claim 1, wherein the coating composition further comprises an additional ingredient selected from colorants, plasticizers, abrasion-resistant particles, anti-oxidants, hindered amine light stabilizers, UV light absorbers and stabilizers, surfactants, flow control agents, thixotropic agents, fillers, reactive diluents, catalysts, grind vehicles, defoamers, dispersants, adhesion promoters, antistatic agents, or mixtures thereof.

11. The method of claim 1, wherein the pulsed infrared radiation has a peak wavelength in the range of from 3 μm to 6 μm or of from 3 μm to 4 μm.

12. The method of claim 1, wherein the pulsed infrared radiation is applied at a pulse duration ranging from 7 μs to 17 μs or from 10 μs to 14 μs.

13. The method of claim 1, wherein the pulsed infrared radiation is applied at a pulse frequency of from 350 Hz to 450 Hz or of from 400 Hz to 450 Hz.

14. The method of claim 1, wherein the pulsed infrared radiation is applied at an impulse energy of from 250 W/cm² to 350 W/cm² or of from 290 W/cm² to 320 W/cm².

15. The method of claim 1, wherein the coating composition is applied to the substrate at a thickness ranging of from 1 to 1500 μm, such as from 50 to 500 μm or from 10 to 60 μm.

16. The method of claim 1, wherein a full cure of the applied coating composition is achieved by applying the pulsed infrared radiation for a time of less than 30 min or less than 25 min or less than 20 min or less than 15 min or less than 10 min.

17. The method of claim 1, wherein the surface temperature of the substrate in (ii) is less than 130° C. or less than 120° C.

18. The method of claim 1, wherein the pulsed infrared radiation is provided by an infrared light source comprising a surface which comprises a ceramic composition capable of absorbing heat and emitting infrared radiation having a peak wavelength in the range of from 3 μm to 10 μm.

19. The method of claim 18, wherein in (ii) the infrared radiation emitting surface of the infrared light source faces the surface of the substrate having applied the coating composition to be cured at a distance of from 5 cm to 30 cm or of from 15 to 25 cm.

20. The method of claim 1, wherein the part of the surface of the substrate to which the coating composition is applied comprises a material selected from metals, plastics, ceramics, glass, wood, paper, cardboard, rubber, leather, textiles, an existing coating, or mixtures thereof.

21. A coated substrate obtained by the method according to claim 1.

22. The coated substrate of claim 21, wherein the coated substrate is a vehicle part.

23. (canceled)

24. (canceled)

25. (canceled)
